(19) United States
(12) Patent Application Publication
(10) Pub. No.: US 2025/0278752 A1
(43) Pub. Date: Sep. 4, 2025

(54) USING LARGE LANGUAGE MODELS (LLMS) TO GENERATE USER BEHAVIOR SURROGATES

(71) Applicant: Maplebear Inc., San Francisco, CA (US)

(72) Inventors: Changyao Chen, New York, NY (US); Jacob Jensen, Metuchen, NJ (US); Levi Boxell, Brownsburg, IN (US); Rustin Partow, San Francisco, CA (US); Yuean Gong, Albany, CA (US)

(21) Appl. No.: 19/070,152

(22) Filed: Mar. 4, 2025

Related U.S. Application Data
(60) Provisional application No. 63/561,202, filed on Mar. 4, 2024.

(51) Int. Cl. G06Q 30/0202; G06F 40/40; G06Q 30/0601

(52) U.S. Cl. CPC G06Q 30/0202; G06F 40/40; G06Q 30/0625; G06Q 30/0633; G06Q 30/0641

(57) ABSTRACT

A method for predicting customer long-term behavior using LLM-based modeling is described. The online system receives a representation of a stimulus or treatment that is presented to a user and generates a summary of a simulated user profile. The online system performs an inference task in conjunction with the model serving system or interface system to infer one or more actions that will likely be performed in response to the representation of the stimulus based on the simulated user profile. The online system computes a surrogate measure based on the response received from the model serving system and computes a correlation coefficient between the surrogate measure and a true metric of interest from collected experiment data. Responsive to determining a correlation coefficient greater than a threshold value, the online system predicts the true metric of interest based on the surrogate measure.

### CROSS REFERENCE TO RELATED APPLICATIONS

This application claims the benefit of U.S. Provisional Application No. 63/561,202 filed Mar. 4, 2024, which is incorporated by reference in its entirety.

### BACKGROUND

One example online system may include an online platform that connects users and retailers. Online systems continuously implement changes to online platforms to improve user experiences and operations of the online platforms. Online systems continuously iterate changes within the online platform to improve the online system's usability, efficiency, and user personalization. Currently, online systems test these changes within the online platform through controlled experiments using A/B testing and real-world feedback. Often times, experiments can be time-consuming and computationally costly and resource intensive. Such traditional experimentation methods introduce delays and efficiencies. Further, testing the effect of implementing a change over an extended time period requires large-scale experimentation that relies on real-time user engagement. This leads to an extended wait time before online systems may analyze the effect of implementing the change.

### SUMMARY

In accordance with one or more aspects of the disclosure, an online system simulates a user's behavior with large language model (LLM)-based modeling. The online system conducts an experiment for a set of users of an online system to obtain one or more observations for a metric of interest, the experiment deploying a set of treatments related to an application of the online system. The online system obtains a representation of a treatment and a simulated user profile for simulation by a machine-learning language model. The online system generates a prompt as input to the machine-learning language model. The prompt may specify at least the simulated user profile and a request to infer one or more actions that a user represented by the simulated user profile will perform in response to being presented with the treatment. The online system receives a response generated by executing the machine-learning language model on the prompt. The online system generates one or more predicted surrogate values for one or more surrogate metrics for the simulated user profile. The online system generates a simulated prediction value for the metric of interest from at least the predicted surrogate values for the one or more surrogate metrics. Responsive to analyzing at least the simulated prediction value for the metric of interest, the online system transmits instructions to a client device to cause display of the treatment to a user of the online system.

### BRIEF DESCRIPTION OF THE DRAWINGS

FIG. 1A illustrates an example system environment for an online system, in accordance with one or more embodiments.

FIG. 1B illustrates an example system environment for an online system, in accordance with one or more embodiments.

FIG. 2 illustrates an example system architecture for an online system, in accordance with one or more embodiments.

FIG. 3 is a flowchart for a method for predicting a metric of interest based on surrogate measures generated by a LLM, in accordance with one or more embodiments.

### DETAILED DESCRIPTION

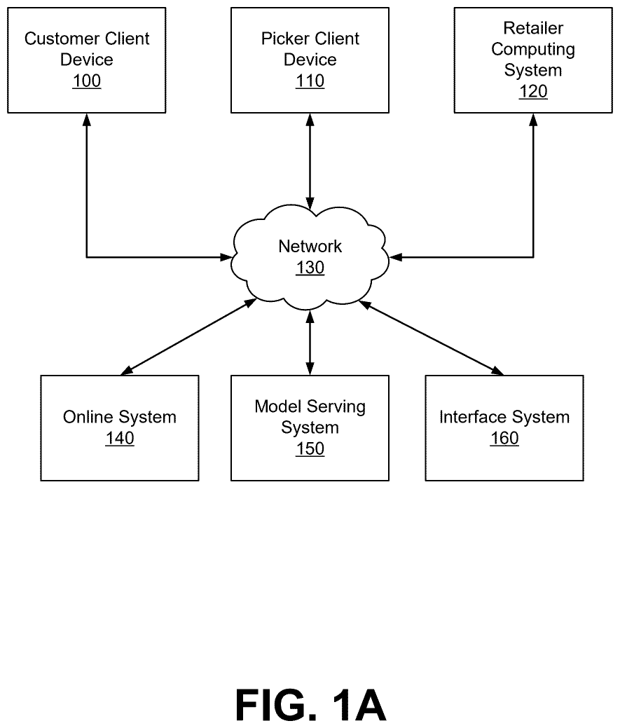

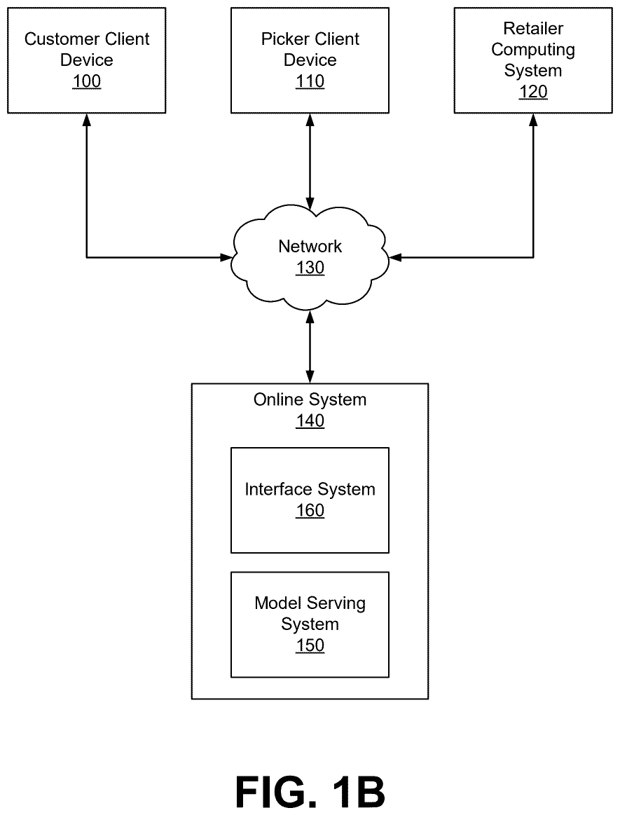

FIG. 1A illustrates an example system environment for an online system 140, in accordance with one or more embodiments. The system environment illustrated in FIG. 1A includes a customer client device 100, a picker client device 110, a retailer computing system 120, a network 130, and an online system 140. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online system 140. Additionally, while one customer client device 100, picker client device 110, and retailer computing system 120 are illustrated in FIG. 1, any number of customers, pickers, and retailers may interact with the online system 140. As such, there may be more than one customer client device 100, picker client device 110, or retailer computing system 120.

The customer client device 100 is a client device through which a customer may interact with the picker client device 110, the retailer computing system 120, or the online system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online system 140.

A customer uses the customer client device 100 to place an order with the online system 140. An order specifies a set of items to be delivered to the customer. An “item”, as used herein, means a good or product that can be provided to the customer through the online system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online system 140. The ordering interface may be part of a client application operating on the customer client device 100. The ordering interface allows the customer to search for items that are available through the online system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the customer client device 100 for display to the customer such that the customer can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online system 140. As used herein, a “retailer” is an entity that operates a “retailer location,” which is a store, warehouse, or other building from which a picker can collect items. The retailer computing system 120 stores and provides item data to the online system 140 and may regularly update the online system 140 with updated item data. For example, the retailer computing system 120 provides item data indicating which items are available at a retailer location and the quantities of those items. Additionally, the retailer computing system 120 may transmit updated item data to the online system 140 when an item is no longer available at the retailer location. Additionally, the retailer computing system 120 may provide the online system 140 with updated item prices, sales, or availabilities. Additionally, the retailer computing system 120 may receive payment information from the online system 140 for orders serviced by the online system 140. Alternatively, the retailer computing system 120 may provide payment to the online system 140 for some portion of the overall cost of a user's order (e.g., as a commission).

The customer client device 100, the picker client device 110, the retailer computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which customers can order items to be provided to them by a picker from a retailer. The online system 140 receives orders from a customer client device 100 through the network 130. The online system 140 selects a picker to service the customer's order and transmits the order to a picker client device 110 associated with the picker. The picker collects the ordered items from a retailer location and delivers the ordered items to the customer. The online system 140 may charge a customer for the order and provides portions of the payment from the customer to the picker and the retailer.

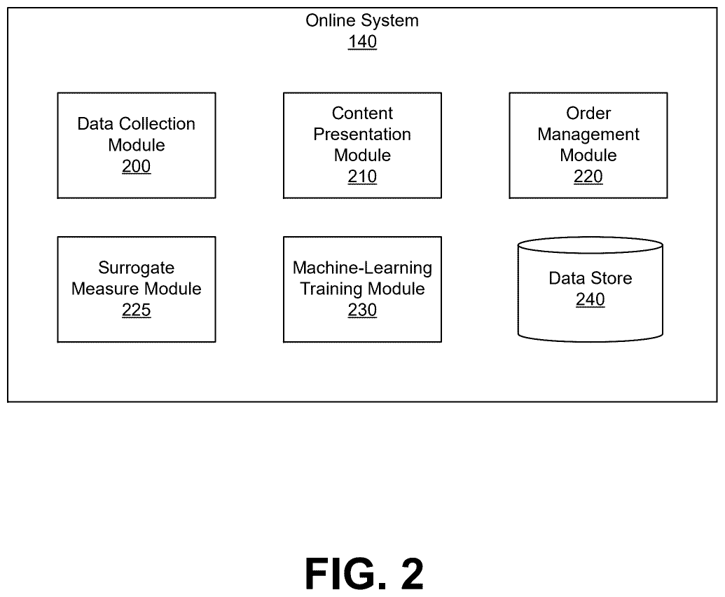

As an example, the online system 140 may allow a customer to order groceries from a grocery store retailer. The customer's order may specify which groceries they want delivered from the grocery store and the quantities of each of the groceries. The customer's client device 100 transmits the customer's order to the online system 140 and the online system 140 selects a picker to travel to the grocery store retailer location to collect the groceries ordered by the customer. Once the picker has collected the groceries ordered by the customer, the picker delivers the groceries to a location transmitted to the picker client device 110 by the online system 140. The online system 140 is described in further detail below with regards to FIG. 2.

The model serving system 150 receives requests from the online system 140 to perform inference tasks using machine-learned models. The inference tasks include, but are not limited to, natural language processing (NLP) tasks, audio processing tasks, image processing tasks, video processing tasks, and the like. In one or more embodiments, the machine-learned models deployed by the model serving system 150 are models configured to perform one or more NLP tasks. The NLP tasks include, but are not limited to, text generation, query processing, machine translation, chatbot applications, and the like. In one or more embodiments, the language model is configured as a transformer neural network architecture. Specifically, the transformer model is coupled to receive sequential data tokenized into a sequence of input tokens and generates a sequence of output tokens depending on the inference task to be performed.

The model serving system 150 receives a request including input data (e.g., text data, audio data, image data, or video data) and encodes the input data into a set of input tokens. The model serving system 150 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learned model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many inference tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units (GPUs) for training or deploying deep neural network models. In one or more instances, the LLM may be trained and hosted on a cloud infrastructure service. The LLM may be trained by the online system 140 or entities/systems different from the online system 140. An LLM may be trained on a large amount of data from various data sources. For example, the data sources include websites, articles, posts on the web, and the like. From this massive amount of data coupled with the computing power of LLMs, the LLM is able to perform various inference tasks and synthesize and formulate output responses based on information extracted from the training data.

In one or more embodiments, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like. The LLM is configured to receive a prompt and generate a response to the prompt. The prompt may include a task request and additional contextual information that is useful for responding to the query. The LLM infers the response to the query from the knowledge that the LLM was trained on and/or from the contextual information included in the prompt.

In one or more embodiments, the inference task for the model serving system 150 can primarily be based on reasoning and summarization of knowledge specific to the online system 140, rather than relying on general knowledge encoded in the weights of the machine-learned model of the model serving system 150. Thus, one type of inference task may be to perform various types of queries on large amounts of data in an external corpus in conjunction with the machine-learned model of the model serving system 150. For example, the inference task may be to perform question-answering, text summarization, text generation, and the like based on information contained in the external corpus.

Thus, in one or more embodiments, the online system 140 is connected to an interface system 160. The interface system 160 receives an external corpus of data from the online system 140 and builds a structured index over the data using another machine-learned language model or heuristics. The interface system 160 receives one or more task requests from the online system 140 based on the external data. The interface system 160 constructs one or more prompts for input to the model serving system 150. A prompt may include the task request of the user and context obtained from the structured index of the external data. In one or more instances, the context in the prompt includes portions of the structured indices as contextual information for the query. The interface system 160 obtains one or more responses to the query from the model serving system 150 and synthesizes a response. While the online system 140 can generate a prompt using the external data as context, oftentimes, the amount of information in the external data exceeds prompt size limitations configured by the machine-learned language model. The interface system 160 can resolve prompt size limitations by generating a structured index of the data and offers data connectors to external data and provides a flexible connector to the external corpus.

In one or more embodiments, the online system 140 performs an inference task in conjunction with the model serving system 150 and/or interface system 160 to simulate user behavior to accurately predict long-term metrics associated with user behavior. Subjective or long-term metrics (e.g., metrics of interest) of user behavior may be challenging to predict without conducting experiments, which can have long observation periods. Hence, surrogate measures, also referred to as a proxy metric, may be used to approximate or predict metrics of interest during testing. A surrogate measure may refer to a surrogate metric or a surrogate index (e.g., combination of surrogate metrics). For example, a metric of interest may be a user's activity in response to a change in membership subscription prices. An example of a surrogate metric may be the user's activity recorded in the first two weeks of an experiment. The surrogate measure may be used to make predictions on the long-term impact of the price change on customer activity. A method for using an LLM to generate the surrogate metrics, and using the surrogate metrics to estimate future user behavior is outlined below. In some instances, generating the surrogate metrics may include identifying the user's total cart spend, which items will the user add to their cart, and will the user perform desired actions, such as clicking on the promotion and start a shopping session if presented with a promotion.

The online system 140 may generate a representation of a stimulus or treatment that is presented to the user. For example, the online system 104 may generate a stimulus or treatment associated with a change made to an aspect of the online system 140, such as a change to the client application, or an aspect relating to user experience. For example, in generating the representation of the stimulus, the online system 140 may generate, for example, a description, a wireframe, and/or a video. The online system 140 generates a summary (e.g., description) of a simulated user profile to provide as context to the LLM.

The online system 140 may construct a prompt to an LLM, the prompt including the representation of the stimulus, a description of a simulated profile of a user, and a task request to infer actions performed in response to the stimulus based on the profile of the user, or other contextual information. In some embodiments, the prompt may include a list of possible actions that can be taken. For these embodiments, the task request may request the LLM to rank or score each possible action of the list of possible actions, where a higher rank or score may indicate a higher likelihood that the user, simulated by the LLM, will take the corresponding possible action.

The online system 140 may receive the response from the LLM and compute the surrogate measure using the actions performed in response to the stimulus. The online system 140 may determine whether the surrogate measure is positively correlated to a true metric of interest from collected experiment data (e.g., A/B testing data). Other correlations may include the correlation between the actions the LLM predicts and the actions a user actually performs, that is, the correlation between the LLM-predicted surrogate measure and the actual, observed surrogate measure if an experiment were run. Another correlation is between the LLM-predicted surrogate measure and the long-term outcome of interest. A positive correlation may provide confidence that patterns observed in the surrogate measure can be used to predict corresponding patterns in the true metric of interest, which can be used to avoid running experiments where appropriate.

In this manner, the online system 140 may simulate user behavior using a machine-learning LLM based on certain changes made to an aspect of the online system, and in turn, shorten the duration of an experiment. Traditional online systems may test these changes through controlled experiments of A/B testing and real-world feedback. The process of simulating these controlled experiments can lead to a time-consuming and computationally costly process. In one or more embodiments, testing the effects of implementing a change over an extended time period through controlled experimentation requires large-scale experimentation leading to an extended wait time before online systems may analyze the effect of implementing the change. The disclosed online system 140, however, describes a method that utilizes an LLM to analyze the effect of implementing a change over an extended time period and can also use the predicted values from the LLM to supplement existing experimental data. This leads to a reduced wait time before determining whether to implement the change. Further, this method also improves scalability by allowing the online system 140 to simulate various changes over an extended time period with reduced computational costs.

FIG. 1B illustrates an example system environment for an online system 140, in accordance with one or more embodiments. The system environment illustrated in FIG. 1B includes a customer client device 100, a picker client device 110, a retailer computing system 120, a network 130, and an online system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 and/or the interface system 160 are each managed by an entity separate from the entity managing the online system 140. In one or more embodiments, as illustrated in the example system environment in FIG. 1B, the model serving system 150 or the interface system 160 is managed and deployed by the entity managing the online system 140.

FIG. 2 illustrates an example system architecture for an online system 140, in accordance with some embodiments. The system architecture illustrated in FIG. 2 includes a data collection module 200, a content presentation module 210, an order management module 220, a surrogate measure module 225, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. The data collection module 200 may only collect data describing a user if the user has previously explicitly consented to the online system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has services orders for the online system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information and/or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In some embodiments, the order data includes user data for users associated with the order, such as customer data for a customer who placed the order or picker data for a picker who serviced the order.

In one or more embodiments, the data collection module 200 also collects communication data, which is different types of communication between shoppers and users of the online system 140. For example, the data collection module 200 may obtain text-based, audio-call, video-call based communications between different shoppers and users of the online system 140 as orders are submitted and fulfilled. The data collection module 200 may store the communication information by individual user, individual shopper, per geographical region, per subset of users having similar attributes, and the like.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine learning models and may be stored in the data store 240.

In some embodiments, the content presentation module 210 scores items based on a search query received from the customer client device 100. A search query is free text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weigh the score for an item based on the predicted availability of the item. Alternatively, the content presentation module 210 may filter out items from presentation to a customer based on whether the predicted availability of the item exceeds a threshold.

In one or more embodiments, the content presentation module 210 receives one or more recommendations for presentation to the customer while the customer is engaged with the ordering interface. The list of ordered items of a customer may be referred to as a basket. As described in conjunction with FIGS. 1A and 1B, the recommendations are generated based on the inferred purpose of the basket of the customer and include one or more suggestions to the customer to better fulfill the purpose of the basket.

In one or more instances, the recommendations are in the form of one or more equivalent baskets that are modifications to an existing basket that serve the same or similar purpose as the original basket. The equivalent basket is adjusted with respect to metrics such as cost, healthiness, whether the basket is sponsored, and the like. For example, an equivalent basket may be a healthier option compared to the existing basket, a less expensive option compared to the existing basket, and the like. The content presentation module 210 may present the equivalent basket to the customer via the ordering interface with an indicator that states how an equivalent basket improves or is different from the existing basket (e.g., more cost-effective, healthier, sponsored by a certain organization). The content presentation module 210 may allow the customer to swap the existing basket with an equivalent basket.

In one or more instances, when the basket includes a list of edible ingredients, the recommendations are in the form of a list of potential recipes the ingredients can fulfill, and a list of additional ingredients to fulfill each recipe. The content presentation module 210 may present each suggested recipe and the list of additional ingredients for fulfilling the recipe to the customer. The content presentation module 210 may allow the customer to automatically place one or more additional ingredients in the basket of the customer.

The order management module 220 that manages orders for items from customers. The order management module 220 receives orders from a customer client device 100 and offers the orders to picker users for service based on picker data. For example, the order management module 220 offers an order to a picker based on the picker's location and the location of the retailer from which the ordered items are to be collected. The order management module 220 may also offer an order to a picker user based on how many items are in the order, a vehicle operated by the picker, the delivery location, the picker's preferences on how far to travel to deliver an order, the picker's ratings by customers, or how often a picker user agrees to service an order.

In some embodiments, the order management module 220 determines when to offer an order to a picker based on a delivery timeframe requested by the customer with the order. The order management module 220 computes an estimated amount of time that it would take for a picker to collect the items for an order and deliver the ordered item to the delivery location for the order. The order management module 220 offers the order to a picker at a time such that, if the picker immediately services the order, the picker is likely to deliver the order at a time within the timeframe. Thus, when the order management module 220 receives an order, the order management module 220 may delay in offering the order to a picker if the timeframe is far enough in the future.

When the order management module 220 offers an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques or models to the images to identify the items depicted by the images. The order management module 220 may track the progress of the picker user as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker user as the picker travels to the delivery location for an order, and updates the customer with the location of the picker so that the customer can track the progress of their order. In one or more embodiments, the order management module 220 computes an estimated time of arrival for the picker at the delivery location and provides the estimated time of arrival to the customer.

In one or more embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The surrogate measure module 225 may predict metrics of interest based on surrogate metrics generated by an LLM. As described above, the surrogate measure module 225 may receive a description or representation of a stimulus or treatment that is presented to users. The description may include image, code, text description of the desired stimulus or treatment. In one or more embodiments, the representation of the stimulus may be generated through manual description of a change, or generated programmatically as a result of an experiment conducted. For example, one might want to determine whether customers are likely to purchase items on an upsell screen that is presented to a user at checkout. In this example, the surrogate measure module 225 may provide sequences of images or wireframes illustrating an upsell screen including different items to an LLM in a prompt. In some embodiments, the surrogate measure module 225 may also provide images or wireframes of a current version of the upsell screen.

The surrogate measure module 225 may generate a simulated user profile. In one or more embodiments, a machine-learning model generates statistically likely user profiles and history based on real user data stored in the data store 240. Marketing data or data gathered from other performed analyses may also be used to create a simulated user profile. For example, a portion of the summary of a simulated user profile may be “[y]ou are a busy mom who wants to create delicious meals for your family,” or “[y]ou are a single male who cooks your own meals, and have no dietary concerns.”

The surrogate measure module 225 may construct a prompt and a task request to the LLM to infer, based on the simulated user's profile, the action that will likely be performed by the simulated user in response to the provided stimulus. In some embodiments, the surrogate measure module 225 may include a list of possible actions in the prompt to the LLM. An example prompt to the LLM of the model serving system 150 may be:
“You are a user of Company A [description of Company A]. You have the following history using the application [Summary of simulated user profile]. During the checkout process, you are presented with the following screen. Select your likely subsequent actions:
   1. Yes, I am likely to purchase the items on the upsell screen.
   2. No, I am not likely to purchase the items on the upsell screen.”

In other embodiments, the surrogate measure module 225 may construct a prompt with a task request that requests the LLM to rank or score each of the possible actions provided. An example prompt to the LLM of the model serving system 150 may be:
“You are a user of Company A [description of Company A]. You have the following history using the application [Summary of simulated user profile]. You receive a notification on your phone telling you that [Description of stimulus]. Rank your likely subsequent actions [Begin shopping session/ignore].”

In one or more embodiments, the surrogate measure module 225 may construct a prompt with a task request that requests the LLM to assess a representation of a stimulus from the perspective of a specialist (e.g., a marketing expert, scientist, or other domain expert). Specifically, the surrogate measure module 225 may provide the specialist role as contextual data to the LLM. As an example, the prompt may include a request to assess a metric of the stimulus from the perspective of a marketing expert (e.g., Customer Acquisition Costs (CAC), Click-Through Rate (CTR), etc.). The above methods may be used in combination to compute a surrogate measure.

The surrogate measure module 225 receives a response from the LLM including a set of surrogate values. The surrogate values may represent the likelihood of performing an action of a set of actions the user associated with the simulated user profile will perform. As an example, the response for the simulated user profile for User A is a 0.7 likelihood that User A is likely to purchase the items on the upsell screen and a 0.3 likelihood that User B is not likely to purchase the items on the upsell screen.

In one more embodiments, the surrogate measure module 225 may validate the surrogate values. In one or more embodiments, the surrogate measure module 225 may validate the surrogate values to determine whether the surrogate values are an accurate representation of the actual actions that the customer associated with the user profile will respond to in response to receiving the stimulus. The validation process may determine if the surrogate values highly correlate to the actual, but often noisy, values of the user in response to the stimulus. If the validation process generates a low correlation between the actual values and the surrogate values, the validation process may indicate that the surrogate model is not a reliable indicator of the true user behavior. Further, a low correlation may indicate that there may be major distributional differences between the surrogate values and the actual customer-level data.

As described above, the surrogate measure module 225 computes a surrogate measure based on the LLM's response to the prompt and compares the surrogate measure to experimentally generated metrics of interest to determine a correlation between the surrogate measure and the true metric. In one or more embodiments, the surrogate measure module 225 may construct a series of prompts, each contingent on an earlier prompt, which generates a set of more than one surrogate metrics. For example, one may want to determine a user's total spend over a three-year duration. The surrogate measure module 225 may generate prompts to the LLM that include task requests to infer surrogate metrics such as application activity, shopping frequency, average order value, etc. The surrogate measure module 225 may compute a surrogate index from the more than one surrogate metrics. In one example arrangement, the surrogate measure module 225 may compute the surrogate index by aggregating weighted surrogate metric values, or using another appropriate ensemble method.

Specifically, surrogate indexes may be indicative of certain metrics of interest that are typically computed over an extended time. As an example, a surrogate index is to estimate a user's satisfaction over three years. Thus, experimental data for surrogate indexes are sparse as conducting experiments over an extended time are computationally costly. The surrogate measure module 225 may use a combination of surrogate metrics to estimate the user's satisfaction over three years. The surrogate measure module 225 may utilize three surrogate metrics to approximate the user's satisfaction—shopping time per order, item substitution rate, and percentage of whether the user tipped the shopper. As an example, the surrogate measure module 225 may determine the surrogate index by applying a weighted sum to the three surrogate metrics. For example, a higher surrogate index may indicate a higher user satisfaction over three years.

The surrogate measure module 225 may determine whether there is a positive correlation between the surrogate measure and a true metric by calculating a correlation coefficient between the surrogate measure and a true metric. Some examples of correlation methods may include, but are not limited to, Pearson's correlation coefficient, Spearman's Rank correlation coefficient, Kendall's Tau Rank correlation coefficient, etc. In addition, metrics may also include average bias, root mean squared error, and the like. For bias, it may be important because two surrogate measures may have the same correlation with observed long-term outcomes, but which would give contrasting decisions on whether a product change is good or bad. In response to determining that the correlation coefficient between the surrogate measure and the true metric is greater than a threshold value, the surrogate measure module 225 may use the surrogate measures to predict estimates of the true metrics with a reduced error. Hence, the duration of experiments may be shortened. Developers may use the predicted true metric to determine whether to deploy certain application features.

In one or more embodiments, responsive to determining that the LLM-generated surrogate data is positively correlated to the metric of interest, the LLM-generated surrogate data may be used to supplement experimental data. Specifically, when running an experiment for the metric of interest, the preliminary experimental data can help inform the surrogate measure module 225 which user populations should be simulated based on the LLM-generated surrogate data. For example, there may be user groups with high variance outcomes, or which have few observations and where simulated data may be useful and help to decrease experiment run time. In one or more instances, when running an experiment with many arms or multi-arm bandits with a continuous action space, there may be arms or actions for which there are few observations. In such an instance, the existing experimental data may be supplemented using a LLM that generates predictions for surrogates. The LLM simulated data may be used directly in the treatment effect estimation or it can be used to inform the experimenter or the multi-arm bandit process on which variants to try next.

In one or more embodiments, the surrogate measure module 225 may determine whether the experimental data for the metric of interest can be supplemented with the LLM-generated surrogate data. The experimental data for the metric of interest generates unbiased, but potentially high variance estimates of the average treatment effects (ATEs) of an action on a set of users. This means that while the experimental data reflects the true values for the metric of interest of the action on the set of users, the experimental data may have a relatively wide range in variance as the individual values for the metric of interest are within a limited sample size of the set of users. On the other hand, the surrogate data simulated by the LLM may generate biased, but potentially lower variance estimates of the ATEs. The LLM-generated surrogate values produce some bias that may be inherent to the properties of an LLM, but have relatively smaller variance when generating the surrogate values.

In one or more embodiments, the surrogate measure module 225 may apply an objective function (e.g., reducing the mean squared error of the ATE estimator) and some measure of the bias of the LLM to the experimental data and the LLM-generated surrogate data to determine the optimal configuration for supplementing the experimental data with the LLM-generated surrogate data. The objective can be constructed as a weighted ATE estimate as weight*ATE (experiment data)+(1-weight)*ATE (LLM data), where the weight is optimized to reduce the error (e.g., MSE) between the objective function and the actual values of the ATE. Given that MSE is bias squared plus the variance, for experimental data, the standard estimates of bias and variance may be generated. In one or more embodiments, the ATE (experimental data) is the predicted ATE value for a user or a subgroup of users using a model that is trained on the experimental data. The ATE (LLM data) is a predictive measure of the ATE value using a surrogate metric simulated using LLMs.

To obtain optimal values for “weight” in the equation above, the surrogate measure module 225 may determine the optimal value for the weight of the objective function for the ATE (LLM data) and the determined ATE (experimental data) values for a given set of users and validate the objective function with actual corresponding samples from the experiment. As an example, the surrogate measure module 225 may be configured to determine an optimal weight for estimating a user's satisfaction over three years for a set of users. The surrogate measure module 225 may apply an experimental data model trained on experimental data to a subset of user profiles to determine the user's satisfaction over three years for the subset of users. The surrogate measure module 225 computes the ATE (experiment) for the subset of users. Given that the metric of interest is over an extended time, the experimental data for the metric of interest may be limited and have high variance.

The surrogate measure module 225 may apply an LLM for the surrogate metric associated with the metric of interest to generate a set of surrogate values for the subset of users. The surrogate values for this metric may have a lower variance due to the use of a predictive and stable model. However, these values may also introduce bias depending on, for example, properties of the LLM such as the training data the parameters were trained on. The surrogate measure module 225 computes an ATE value based on the surrogate values. The surrogate measure module 225 determines a weight that reduces or minimizes the MSE between the objective function: ATE (experiment data)+(1-weight)*ATE (LLM data) and actual known values from the experiment for the same sample.

In one or more embodiments, for LLM simulated data, one option is to review historical experiments and simulate LLM data for these experiments. As an example, the surrogate measure module 225 may compute the optimal weight for the ATE estimate equation when restricted to 10% of the experimental data for a historical experiment, if benchmarked against the 100% experimental data ATE.

In one or more embodiments, a Bayesian approach could also be used for combining the two data sources. The combination of LLM and experimental data can be done for estimating average treatment effects, but also heterogeneous treatment effects across certain user subgroups, such as new and existing users.

In one or more embodiments, the surrogate measure module 225 may fine-tune parameters of the machine-learning language model based on verifying the surrogate predictions made by the LLM. Responsive to verifying the one or more surrogate values are within a threshold level of accuracy (e.g., compared to actual observations), the surrogate measure module 225 generates a training example including the prompt and the one or more surrogate values. The surrogate measure module 225 applies parameters of the machine-learning language model to generate estimated outputs. The surrogate measure module 225 generates a loss function that indicates a difference between the estimated outputs and the one or more surrogate values. The surrogate measure module 225 fine-tunes the parameters of the machine-learning language model to reduce the loss function

The machine learning training module 230 trains machine learning models used by the online system 140. For example, the machine learning module 230 may train the item selection model, the availability model, or any of the machine-learned models deployed by the model serving system 150. The online system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross entropy loss function. The machine learning training module 230 updates the set of parameters for the machine learning model based on the score generated by the loss function. For example, the machine learning training module 230 may apply gradient descent to update the set of parameters.

The data store 240 stores data used by the online system 140. For example, the data store 240 stores customer data, item data, order data, and picker data for use by the online system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data.

With respect to the machine-learned models hosted by the model serving system 150, the machine-learned models may already be trained by a separate entity from the entity responsible for the online system 140. In another embodiment, when the model serving system 150 is included in the online system 140, the machine-learning training module 230 may further train parameters of the machine-learned model based on data specific to the online system 140 stored in the data store 240. As an example, the machine-learning training module 230 may obtain a pre-trained transformer language model and further fine tune the parameters of the transformer model using training data stored in the data store 240. The machine-learning training module 230 may provide the model to the model serving system 150 for deployment.

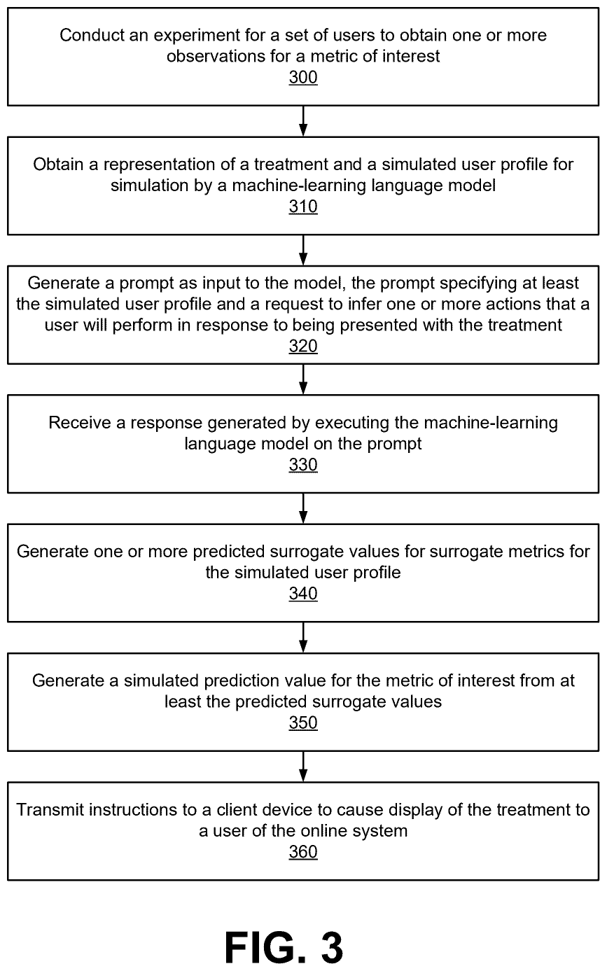

FIG. 3 is a flowchart for a method for predicting a metric of interest based on surrogate measures generated by a LLM, in accordance with some embodiments. Alternative embodiments may include more, fewer, or different steps from those illustrated in FIG. 3, and the steps may be performed in a different order from that illustrated in FIG. 3. These steps may be performed by an online system (e.g., online system 140). Additionally, each of these steps may be performed automatically by the online system without human intervention.

The online system 140 conducts 300 an experiment for a set of users of an online system to obtain one or more observations for a metric of interest. In one or more embodiments, the experiment deploys a set of treatments related to an application of the online system. The online system 140 obtains 310 a representation of a treatment and a simulated user profile for simulation by a machine-learning language model. The online system 140 generates 320 a prompt as input to the machine-learning language model, the prompt specifying at least the simulated user profile and a request to infer one or more actions that a user represented by the simulated user profile will perform in response to being presented with the treatment. The online system 140 receives 330 a response generated by executing the machine-learning language model on the prompt. The online system 140 generates 340, based on the response from the machine-learning language model, one or more predicted surrogate values for one or more surrogate metrics for the simulated user profile. The online system 140 generates 350 a simulated prediction value for the metric of interest from at least the predicted surrogate values for the one or more surrogate metrics. Responsive to analyzing at least the simulated prediction value for the metric of interest, the online system 140 transmits 360 instructions to a client device to cause display of the treatment to a user of the online system.

### Additional Considerations

The foregoing description of the embodiments has been presented for the purpose of illustration; many modifications and variations are possible while remaining within the principles and teachings of the above description. Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method comprising:
conducting an experiment for a set of users of an online system to obtain one or more observations for a metric of interest, the experiment deploying a set of treatments related to an application of the online system;
obtaining a representation of a treatment and a simulated user profile for simulation by a machine-learning language model;
generating a prompt as input to the machine-learning language model, the prompt specifying at least the simulated user profile and a request to infer one or more actions that a user represented by the simulated user profile will perform in response to being presented with the treatment;
receiving a response generated by executing the machine-learning language model on the prompt;
generating, based on the response from the machine-learning language model, one or more predicted surrogate values for one or more surrogate metrics for the simulated user profile;
generating a simulated prediction value for the metric of interest from at least the predicted surrogate values for the one or more surrogate metrics; and
responsive to analyzing at least the simulated prediction value for the metric of interest, transmitting instructions to a client device to cause display of the treatment to a user of the online system.

2. The method of claim 1, wherein the experiment is a multi-arm bandit with multiple actions, and wherein the simulated prediction value for the metric of interest obtained from at least the predicted surrogate values is a treatment effect estimate for the treatment.

3. The method of claim 2, further comprising:
generating a second treatment effect estimate for the treatment from the one or more observations obtained from the experiment; and
applying a weighted combination of the second treatment effect estimate and the treatment effect estimate to generate a combined treatment effect for the treatment.

4. The method of claim 3, identifying a weight value for the weighted combination, further comprising:
obtaining a set of historical observations for the metric of interest;
generating estimates for combined treatment effects based on an estimated weight value; and
identifying the weight value that reduces a difference between the set of historical observations and the estimates for combined treatment effects.

5. The method of claim 1, further comprising identifying characteristics of a group of users to generate simulated data for, and wherein the simulated user profile corresponds to the characteristics of the group of users.

6. The method of claim 1, further comprising verifying whether the one or more predicted surrogate values from the machine-learning language model is indicative of the metric of interest, further comprising:
generating a correlation coefficient between the simulated prediction value and the one or more observations for the metric of interest; and
responsive to the correlation coefficient being above a threshold value, verifying that the one or more predicted surrogate values is indicative of the metric of interest.

7. The method of claim 1, wherein the treatment represents one or a combination of a modification to a user interface element of the application of the online system or providing a content item for presentation.

8. The method of claim 1, further comprising:
responsive to verifying the one or more surrogate values, generating a training example including the prompt and the one or more surrogate values;
applying parameters of the machine-learning language model to generate estimated outputs;
generating a loss function that indicates a difference between the estimated outputs and the one or more surrogate values; and
fine-tuning the parameters of the machine-learning language model to reduce the loss function.

9. A non-transitory computer-readable medium storing instructions that, when executed by one or more computer processors, cause the one or more computer processors to perform operations comprising:
conducting an experiment for a set of users of an online system to obtain one or more observations for a metric of interest, the experiment deploying a set of treatments related to an application of the online system;
obtaining a representation of a treatment and a simulated user profile for simulation by a machine-learning language model;
generating a prompt as input to the machine-learning language model, the prompt specifying at least the simulated user profile and a request to infer one or more actions that a user represented by the simulated user profile will perform in response to being presented with the treatment;
receiving a response generated by executing the machine-learning language model on the prompt;
generating, based on the response from the machine-learning language model, one or more predicted surrogate values for one or more surrogate metrics for the simulated user profile;
generating a simulated prediction value for the metric of interest from at least the predicted surrogate values for the one or more surrogate metrics; and
responsive to analyzing at least the simulated prediction value for the metric of interest, transmitting instructions to a client device to cause display of the treatment to a user of the online system.

10. The non-transitory computer-readable medium of claim 9, wherein the experiment is a multi-arm bandit with multiple actions, and wherein the simulated prediction value for the metric of interest obtained from at least the predicted surrogate values is a treatment effect estimate for the treatment.

11. The non-transitory computer-readable medium of claim 10, wherein the operations further comprise:
generating a second treatment effect estimate for the treatment from the one or more observations obtained from the experiment; and
applying a weighted combination of the second treatment effect estimate and the treatment effect estimate to generate a combined treatment effect for the treatment.

12. The non-transitory computer-readable medium of claim 11, wherein operations for identifying a weight value for the weighted combination further comprises:
obtaining a set of historical observations for the metric of interest;
generating estimates for combined treatment effects based on an estimated weight value; and
identifying the weight value that reduces a difference between the set of historical observations and the estimates for combined treatment effects.

13. The non-transitory computer-readable medium of claim 9, the operations further comprising identifying characteristics of a group of users to generate simulated data for, and wherein the simulated user profile corresponds to the characteristics of the group of users.

14. The non-transitory computer-readable medium of claim 9, the operations further comprising verifying whether the one or more predicted surrogate values from the machine-learning language model is indicative of the metric of interest, wherein operations for verifying further comprises:
generating a correlation coefficient between the simulated prediction value and the one or more observations for the metric of interest; and
responsive to the correlation coefficient being above a threshold value, verifying that the one or more predicted surrogate values is indicative of the metric of interest.

15. The non-transitory computer-readable medium of claim 9, wherein the treatment represents one or a combination of a modification to a user interface element of the application of the online system or providing a content item for presentation.

16. The non-transitory computer-readable medium of claim 9, the operations further comprising:
responsive to verifying the one or more surrogate values, generating a training example including the prompt and the one or more surrogate values;
applying parameters of the machine-learning language model to generate estimated outputs;
generating a loss function that indicates a difference between the estimated outputs and the one or more surrogate values; and
fine-tuning the parameters of the machine-learning language model to reduce the loss function.

17. A computer system, comprising:
one or more computer processors; and
a non-transitory computer-readable medium storing instructions that, when executed by one or more computer processors, cause the one or more computer processors to perform operations comprising:
conducting an experiment for a set of users of an online system to obtain one or more observations for a metric of interest, the experiment deploying a set of treatments related to an application of the online system;
obtaining a representation of a treatment and a simulated user profile for simulation by a machine-learning language model;
generating a prompt as input to the machine-learning language model, the prompt specifying at least the simulated user profile and a request to infer one or more actions that a user represented by the simulated user profile will perform in response to being presented with the treatment;
receiving a response generated by executing the machine-learning language model on the prompt;
generating, based on the response from the machine-learning language model, one or more predicted surrogate values for one or more surrogate metrics for the simulated user profile;
generating a simulated prediction value for the metric of interest from at least the predicted surrogate values for the one or more surrogate metrics; and
responsive to analyzing at least the simulated prediction value for the metric of interest, transmitting instructions to a client device to cause display of the treatment to a user of the online system.

18. The computer system of claim 17, wherein the experiment is a multi-arm bandit with multiple actions, and wherein the simulated prediction value for the metric of interest obtained from at least the predicted surrogate values is a treatment effect estimate for the treatment.

19. The computer system of claim 18, wherein the operations further comprise:
generating a second treatment effect estimate for the treatment from the one or more observations obtained from the experiment; and
applying a weighted combination of the second treatment effect estimate and the treatment effect estimate to generate a combined treatment effect for the treatment.

20. The computer system of claim 17, the operations further comprising identifying characteristics of a group of users to generate simulated data for, and wherein the simulated user profile corresponds to the characteristics of the group of users.
